(19) United States
(12) Patent Application Publication
(10) Pub. No.: US 2006/0201343 A1
(43) Pub. Date: Sep. 14, 2006

(54) Device for introducing brine into an animal product

(75) Inventor: George Lambertus Josephus Maria Boogers, Uden (NL)

Correspondence Address: THE WEBB LAW FIRM, P.C., 700 KOPPERS BUILDING, 436 SEVENTH AVENUE, PITTSBURGH, PA, 15219, US

(73) Assignee: CFS BAKEL B.V., Bakel (NL)

(21) Appl. No.: 11/339,323

(22) Filed: Jan. 25, 2006

(30) Foreign Application Priority Data
Jan. 24, 2005 (NL) 1028102

(51) Int. Cl. B02C 11/08

(52) U.S. Cl. 99/532

(57) ABSTRACT

A device for introducing a liquid, such as brine, into an animal product, such as meat, ham and the like, comprises a mounting member on which the product can be arranged and a holder at some distance from the mounting member. The holder bears hollow needles oriented transversely with respect to the mounting member and can be moved to and fro transversely to the mounting member for inserting the needles into the product or, alternatively, for extracting the needles from the product. Said needles have at least one discharge orifice near their free end and one feed orifice at some distance from said free end and are accommodated in the holder such that they can be displaced in the longitudinal direction between a position projecting relatively far out of the holder, in which the feed orifices are blocked, and a position projecting relatively less far out of the holder, in which the feed orifices have a flow connection to a liquid supply. The liquid supply comprises channels located in the holder.

The invention relates to a device for introducing a liquid, such as brine, into an animal product, such as meat, ham and the like, comprising a mounting member on which the product can be arranged, a holder at some distance from the mounting member, which holder bears a multiplicity of hollow needles oriented transversely with respect to the mounting member and which holder can move to and fro transversely to the mounting member for inserting the needles into the product or, alternatively, for extracting the needles from the product, which needles have at least one discharge orifice near their free end and one feed orifice at some distance from said free end, which needles are accommodated in the holder such that they can be displaced in the longitudinal direction between a position projecting relatively far out of the holder, in which the feed orifices are blocked, and a position projecting relatively less far out of the holder, in which the feed orifices have a flow connection to a liquid supply.

A device of this type is known. The holder thereof is a component rigidly accommodated in a frame that also constitutes a boundary for a liquid reservoir. This known device has various disadvantages. First of all, cleaning the needles and the associated guide mechanisms is troublesome. The needles and the holder cannot easily be taken apart, so cleaning cannot always be done satisfactorily or is associated with a relatively long downtime of the device in connection with taking apart and putting together the various components. This also means that it is not easy to replace the needles.

The aim of the invention is therefore to provide a device of the abovementioned type which does not have these disadvantages. This aim is achieved in that the liquid supply comprises channels located in the holder. As a result of the presence of the channels in the holder the liquid reservoir can be arranged some distance away. The holder thus no longer constitutes a boundary for said liquid reservoir, such that the holder is more easily accessible and can even be removed without problems in connection with maintenance, cleaning and the like.

The setup of the needles can also be implemented in a better, more stable manner. For instance, each needle can extend right across a channel in such a way that in the position of the needles projecting relatively less far out of the holder there is a flow connection between the feed orifices and a channel. The needles can in particular be stably supported if pairs of openings open into the channels, which openings of each pair are aligned with respect to one another and define a passage for one needle in each case oriented transversely to the channel. Preferably several parallel channels are provided, wherein a series of needles positioned in parallel alongside and at some distance from each other extends through each channel.

In a preferred embodiment the holder comprises a block or a plate of relatively large thickness. Such a holder can be accommodated in a detachable manner on a frame, which frame and holder are provided with a liquid coupling. The frame preferably comprises an accommodation space enclosed by two supports opposite one another, while the holder is accommodated with a tight fit in said accommodation space. In this embodiment the block can be very easily placed in the frame or removed from the frame, so that cleaning and possible replacement of the needles can be carried out very quickly and easily.

In one of the supports there can be a liquid chamber which has a number of branches which open into the accommodation space, while the holder can have a number of channels, each of which is connected to a respective branch. According to a preferred embodiment the ends of the channels facing the branches can each have a sealing ring which interacts in a sealing manner with the opposing wall of the support in which the branches emerge. Furthermore, the channels can extend between two opposite sides of the holder and have a sealing ring at each end which interacts in a sealing manner with a respective support. In this embodiment the block may be placed in the frame in two orientations, with one of the ends of the channels adjoining the branches in the support concerned in each case. The other ends are then sealed with respect to the other support.

According to the invention the device can have several holders next to one another. In the event of damage or the like, only the block in which the damaged needle occurs then needs to be removed, thus simplifying the repair work. The size of the device can also be quite easily adapted by using more or fewer such blocks.

The invention also relates to a holder for a device as described above.

The invention will be explained in more detail below with reference to an illustrative embodiment shown in the figures.

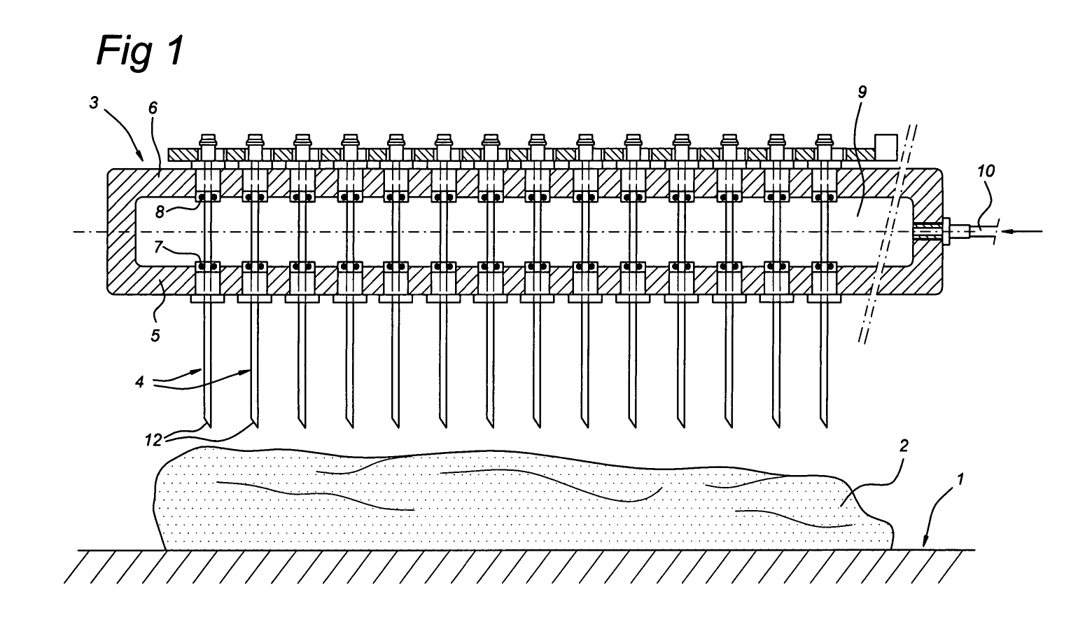

FIG. 1 shows diagrammatically a cross-section through a device according to the invention.

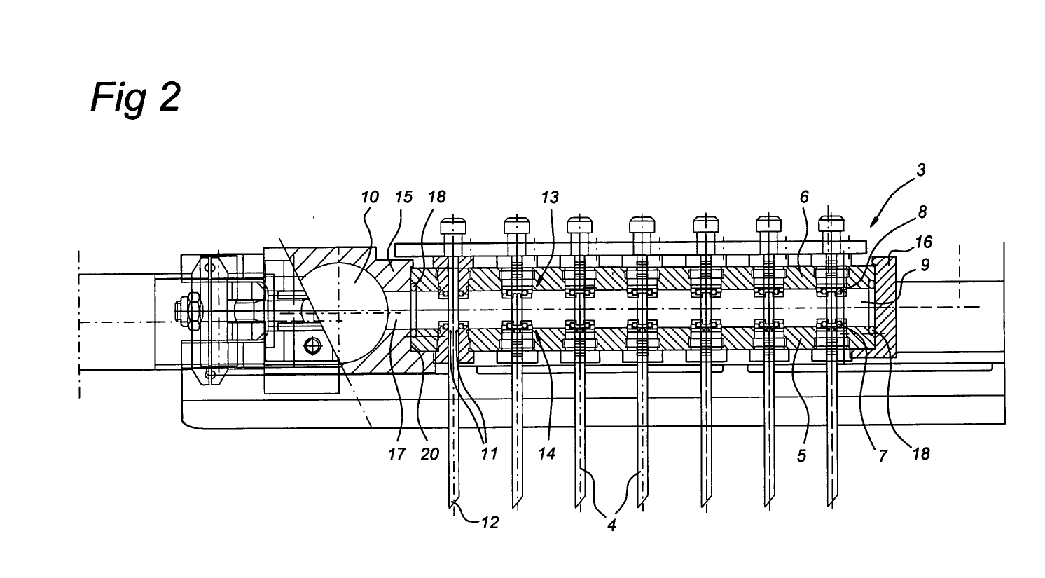

FIG. 2 shows a cross-section on a larger scale.

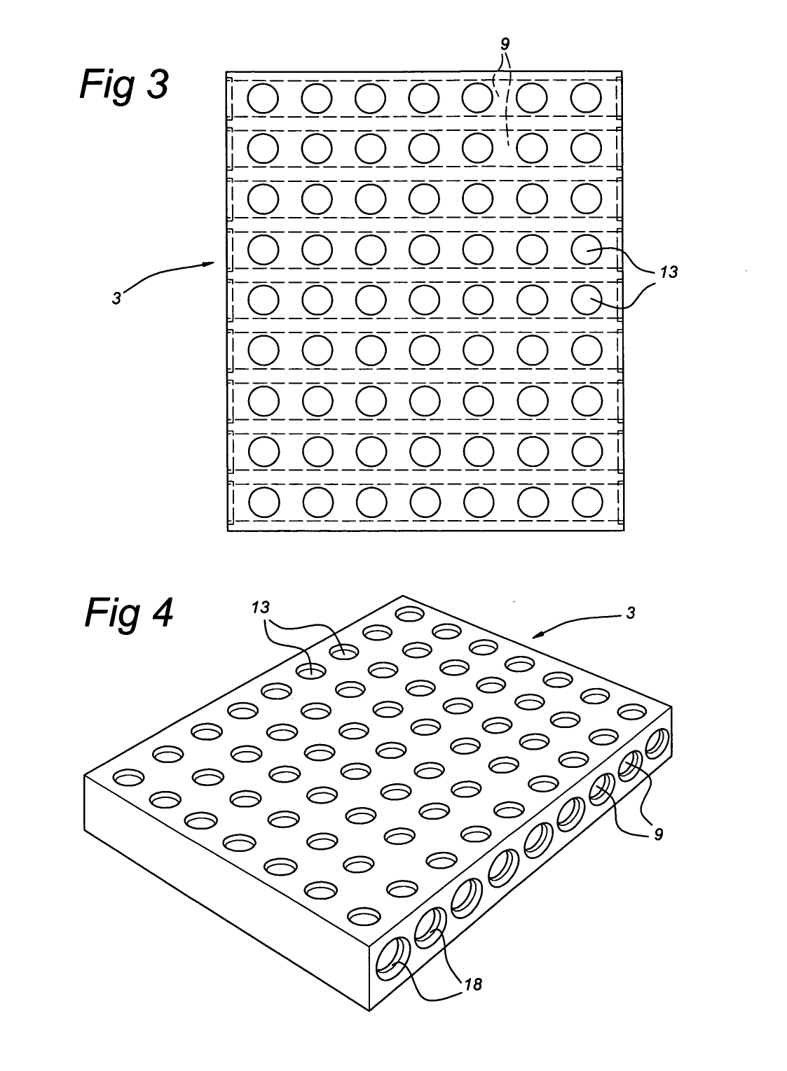

FIG. 3 shows a plan view of the holder

FIG. 4 shows a perspective view of the holder.

The device shown in cross-section in FIG. 1 for introducing a liquid comprises a mounting member 1 on which a meat product 2 is located. The holder, indicated by 3 and from the underside of which a multiplicity of needles 4 projects, is positioned above the mounting member 1. The holder 3 has a lower wall 5 and an upper wall 6, through which the needles are directed via sealing rings 7, 8, respectively: see also FIG. 4.

Between the walls 5, 6 of the holder 3 are channels 9, to which a liquid, such as brine, can be fed via the liquid supply 10.

For introduction of the liquid into the meat product 2, the holder 3 is moved in its entirety downwards towards the mounting member 1. The needles 4 are then in the position shown in FIG. 2. In this position the feed orifice 11 is situated just past the bottom sealing ring 7 with respect to the chamber 9. Consequently, the liquid cannot penetrate into the hollow needles 4 from the chamber 9.

As soon as one or more needles 4 come into contact with the meat product 2, they are pushed up slightly with respect to the holder 3. There is then a flow connection between the feed orifice 11 and the chamber 9, such that the liquid can flow towards the discharge orifices 12 at the bottom of the needles 4. At this point introduction of the liquid into the meat product 2 begins. Of importance is the fact that the needles 4 which are not in contact with the meat product remain closed so that no liquid is lost.

According to the invention the holder 3 is provided with a series of parallel channels 9 into which pairs of openings 13, 14 open. The holder 3 consists of a block or a relatively thick plate and thus constitutes an entity. It is preferably made of a plastic.

As shown in FIG. 2, the holder 3 is accommodated on a pair of supports 15, 16. A main channel 10, from where branches 17 extend transversely that are aligned with respect to one channel 9 each, is located in support 15. The holder 3 is accommodated with a tight fit between the supports 15, 16 and sealed with respect to the branches 17 by O-rings 18. On the other side of the holder 3, the channels 9 are sealed with respect to support 16 by O-rings 18.

The advantage of the holder 3 according to the invention is that it can be removed very easily from the supports 15, 16 in connection with cleaning or replacing needles and the like.

1-18. (canceled)

19. A device for introducing a liquid, into an animal product comprising a mounting member, on which the product can be arranged, a holder at some distance from the mounting member, which holder bears a multiplicity of hollow needles oriented transversely with respect to the mounting member and which holder can move to and fro transversely to the mounting member for inserting the needles into the product or for extracting the needles from the product, which needles have at least one discharge orifice near a free end and one feed orifice at some distance from said free end, which needles are accommodated in the holder such that they can be displaced in the longitudinal direction between a position projecting relatively far out of the holder, in which the feed orifices are blocked, and a position projecting relatively less far out of the holder, in which the feed orifices have a flow connection to a liquid supply, wherein the holder defines liquid supply channels.

20. The device according to claim 19, wherein each needle extends across a channel in such a way that in the position of the needles projecting relatively less far out of the holder there is a flow connection between the feed orifices and said channel.

21. The device according to claim 20, wherein a plurality of parallel channels are provided and a series of needles positioned in parallel alongside and some distance from each other extends through each channel.

22. The device according to claim 21, wherein the holder comprises a block or a plate of relatively large thickness.

23. The device according to claim 22, wherein pairs of openings open into the channels, which openings of each pair are aligned with respect to one another and define a passage for one needle in each case oriented transversely to the channel.

24. The device according to claim 23, wherein in each opening there is a sealing ring in which the needle is accommodated such that it can be displaced.

25. The device according to claim 19, wherein the holder is accommodated in a detachable manner on a frame and the frame and the holder are provided with a liquid coupling.

26. The device according to claim 25, wherein the frame defines an accommodation space enclosed by two supports opposite one another and the holder is accommodated with a tight fit in said accommodation space.

27. The device according to claim 26, wherein in one of the supports there is a liquid chamber which has a number of branches which open into the accommodation space and the holder has a number of channels, each of which is connected to a respective branch.

28. The device according to claim 27, wherein the ends of the channels facing the branches each have a sealing ring which interacts in a sealing manner with an opposing wall of the support in which the branches emerge.

29. The device according to claim 27, wherein the channels extend between two opposite sides of the holder and have a sealing ring at each end which interacts in a sealing manner with a respective support.

30. The device according to claim 19, wherein several holders are provided next to one another.

31. A holder for a device according to claim 19, wherein said channels have connecting means at one end for supplying a liquid, and said device defines openings oriented transversely to the channels for accommodating hollow needles.

32. The holder according to claim 31, wherein the channels have connecting means at two opposite ends for supplying a liquid.

33. The holder according to claim 31, wherein a plurality of parallel channels are provided.

34. The holder according to claim 31, wherein pairs of openings open into the channels, which openings of each pair are aligned with respect to one another and define a passage for one needle in each case oriented transversely to the channel.

35. The holder according to claim 34, wherein in each opening there is a sealing ring in which the needle can be accommodated.

36. The holder according to claim 31, comprising a block or a plate of relatively large thickness.
